(19) United States
(12) Patent Application Publication
(10) Pub. No.: US 2024/0246254 A1
(43) Pub. Date: Jul. 25, 2024

(54) DOORS AND SYSTEMS AND METHODS OF MAKING THE SAME

(71) Applicant: Masonite Corporation, Tampa, FL (US)

(72) Inventors: Bei-Hong LIANG, Naperville, IL (US); Jim P. PFAU, Kirkland, IL (US); Steven B. SWARTZMILLER, Batavia, IL (US)

(21) Appl. No.: 18/422,784

(22) Filed: Jan. 25, 2024

Related U.S. Application Data
(60) Provisional application No. 63/440,989, filed on Jan. 25, 2023.

(51) Int. Cl. B27G 11/00; E06B 3/70

(52) U.S. Cl. CPC B27G 11/005; E06B 3/7001; E06B 2003/7019; E06B 2003/7046

(57) ABSTRACT

Doors, systems and methods of making the same are described, including use of an adhesive that is capable of achieving green strength in a predetermined time, including for exemplary automated embodiments, to prevent movement of the components relative to each other.

### CROSS REFERENCE TO RELATED APPLICATIONS

This application claims priority to U.S. Provisional Application No. 63/440,989 filed Jan. 25, 2023, the disclosure of which is incorporated herein by reference.

### FIELD

The present disclosure relates to doors, and to system and methods of making the same.

### BACKGROUND

Solid, natural wood provides aesthetic qualities that are desirable to many consumers and therefore preferred for various products. However, solid, natural wood is a relatively expensive material, and thus products made from solid, natural wood generally are more expensive than products made from alternative materials such as plastics or wood composites. As the price of natural wood has increased, the market for manufactured products that simulate natural wood has grown.

The door market is an example of a market in which natural wood has been replaced with simulated wood and other materials. Assembled doors simulating natural wood doors are well known in the art. Such doors typically include a peripheral frame and two door facings (also known in the art and referred to herein as door skins) respectively secured to opposing surfaces of the frame. The door facings may be formed from wood composite, such as hardboard, medium density fiberboard (MDF), oriented strand board, wood-plastic composites, etc. It is also known to form door facings from sheet molding compounds (SMCs) containing a thermosetting polymer and fiberglass, and from thermoplastic compounds typically reinforced with fiberglass. Steel and other metals are further examples of alternative materials from which the door facings may be made.

The entirety of the exterior surfaces of the door facings may be planar (or “flush”) so as to lie in a single plane. Alternatively, the exterior surfaces of the door facings may include transition regions or contoured regions surrounding panels, which typically are either coplanar with or recessed from the main body area of the door facing surrounding the transition/contoured regions. The main body area of the door facings surrounding the panels and transition regions is often designed with woodgrain patterns arranged perpendicularly to simulate stiles and rails, as found in traditional rail-and-stile solid wood doors. The exterior surface of the door facings may be smooth, or they may be textured, for example, to provide for the appearance of woodgrain and optionally wood background tones.

Typically, the peripheral frame and the door facings define an internal cavity that may include a core. It is desirable for the core to provide rigidity and structural integrity to the door, as well as thermal and acoustic characteristics. To achieve those properties, the core often is made to fill the entire internal cavity. One way of filling the internal cavity with a core is to inject expanding foam through one or more holes drilled in the peripheral frame and allow the foam to expand and cure.

Another option for filling the internal cavity of the door is to provide a prefabricated solid core. The prefabricated solid cores require machining (e.g., routing) or other shaping of the opposing surfaces of the core to match thickness variations in the internal cavity due to the contours of the transition regions and recessing of the panels of the door facings. The prefabricated solid cores cannot be universally applied to a wide variety of door designs and must be tailored for each door design.

Door assembly in any form presents a number of challenges in order to present a quality product without noticeable defects, which may be caused from a variety of factors, e.g., warping of skins during application of those skins (with warping occurring generally because of temperature or humidity, based on delay of application or inaccurate application of facings, or skins, etc.), general delay during assembly of components, including core components, lack of adhesive bonding or incomplete or delayed bonding between components during assembly, etc.

What is needed in the art are techniques for door manufacturing that alleviate the problems and deficiencies of the prior art.

### SUMMARY

The present disclosure overcomes the problems and disadvantages in the prior art by providing doors and systems and methods for assembly of doors, wherein the components to be assembled can advantageously be maintained in position, without shifting, as the door being assembled is being transported along the assembly line.

To maintain the position of the components relative to each other, the present disclosure describes use of an adhesive that is capable of quickly achieving green strength (as defined below) to prevent movement of the components relative to each other. The time to achieve green strength may be controlled by the manner in which the adhesive is applied to the door components and also by appropriately selecting the adhesive(s).

In exemplary aspects described herein, systems and methods for assembling doors use particular adhesive properties and particular timings for both laying down adhesive and achieving green strength during assembly.

In further exemplary aspects described herein, automated systems and methods for door assembly include predetermined times for depositing adhesive during automated assembly steps, combined with adhesive property aspects determined by the present disclosure to be advantageous for assembly of doors in order to minimize or to eliminate defects and to ensure quality of construction during such assembly.

In further exemplary aspects, with regard to adhesives, a polyurethane reactive (PUR) adhesive is utilized. In additional exemplary embodiments, such PUR adhesive, when placed on a door skin, has one or more of: a viscosity of about 4600-7000 centi-Pascals (cPs); an open time of 40-60 seconds (open time being time before the adhesive begins to form a skin); and a temperature of 275-300 degrees Fahrenheit.

In further exemplary aspects, the unit coat weight of the adhesive on a door skin is between about 0.20-0.30 grams per inch (g/in) for plural lines of beads provided thereon (e.g., with two lines of beads spaced around 9/16 inch (+/−0.005 inches) from the center line of a frame having a width of about 1 ⅛ in., with each bead having a diameter of about 0.050 to about 0.065 inches).

Other exemplary aspects are described below relative to various exemplary steps for assembly of a door, including further adhesive options, application and pressure timings for such steps (e.g., for application of a second door skin), finishing options, core component options, door skin styles and options, etc.

### BRIEF DESCRIPTION OF THE DRAWING(S)

The accompanying drawings are incorporated in and constitute a part of the specification. The drawings, together with the general description given above and the detailed description of the exemplary embodiments and methods given below, serve to explain the principles of the invention. In such drawings:

FIG. 1 is a front perspective view of an exemplary door in accordance with the present disclosure;

FIG. 2 is a plan view of the exemplary door of FIG. 1 with the first door facing removed;

FIG. 3 is a cross-section of the exemplary door of FIG. 1 taken along sectional line 3-3 (shown in FIG. 2);

FIG. 4 is an exploded view of the exemplary door as shown in FIG. 3;

FIG. 5 is a cross-section of the exemplary door of FIG. 1 taken along sectional line 5-5 (shown in FIG. 2);

FIG. 6 is an exploded view of the exemplary door of FIG. 5;

FIG. 7 is a flow diagram showing exemplary steps in forming a door;

FIG. 8 is a cross-section showing exemplary placement of the frame on the first door facing;

FIG. 9 is a cross-section showing exemplary placement of core inserts on the first door facing;

FIG. 10 is a drawing of a partial view of an edge of the second interior surface on the second door skin showing exemplary location of adhesive lines thereon (the long dash line shows the location where the frame attaches to the second door skin);

FIG. 11 is a cross-section showing exemplary placement of a second door facing on the door frame; and

FIG. 12 is a photograph showing an exemplary sample of adhesive lines illustrated in FIG. 10.

### DETAILED DESCRIPTION

Reference will now be made in detail to exemplary embodiments and methods of the invention. It should be noted, however, that the invention in its broader aspects is not necessarily limited to the specific details, representative materials and methods, and illustrative examples shown and described in connection with the exemplary embodiments and methods.

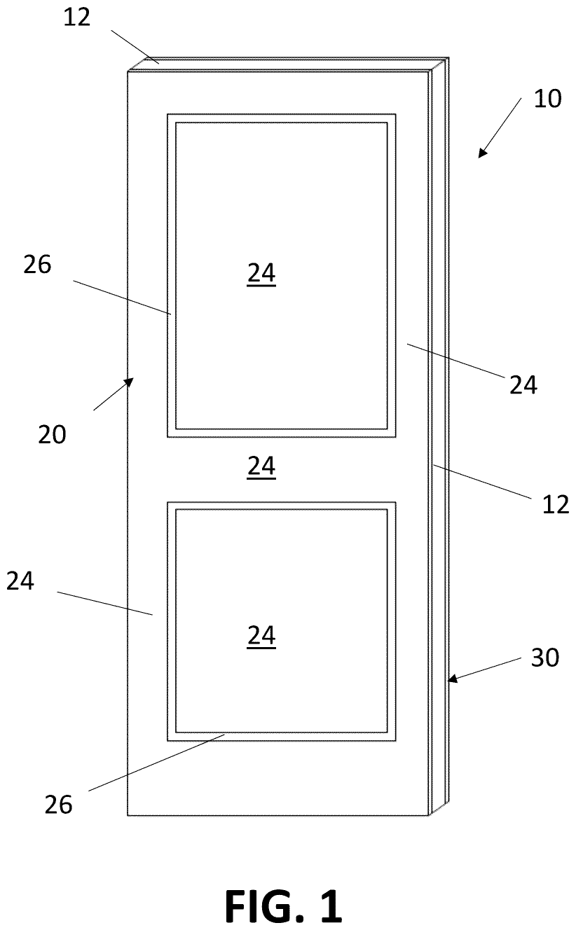

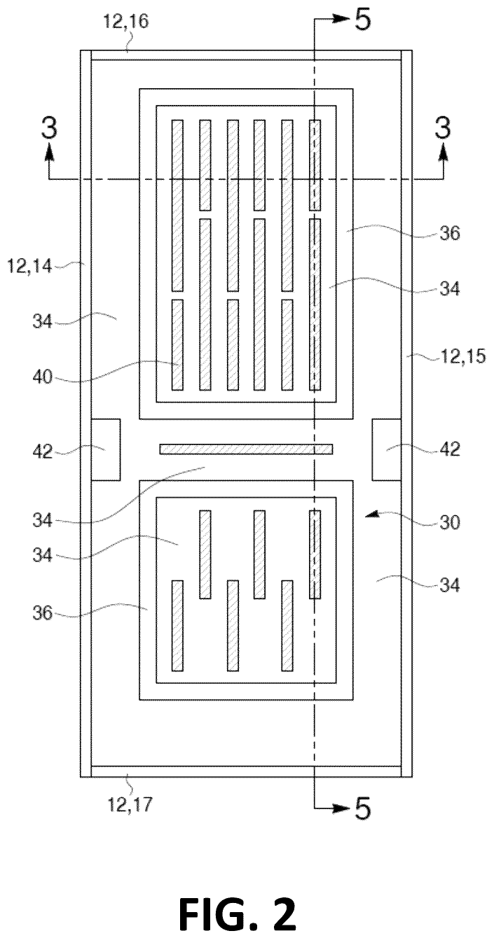

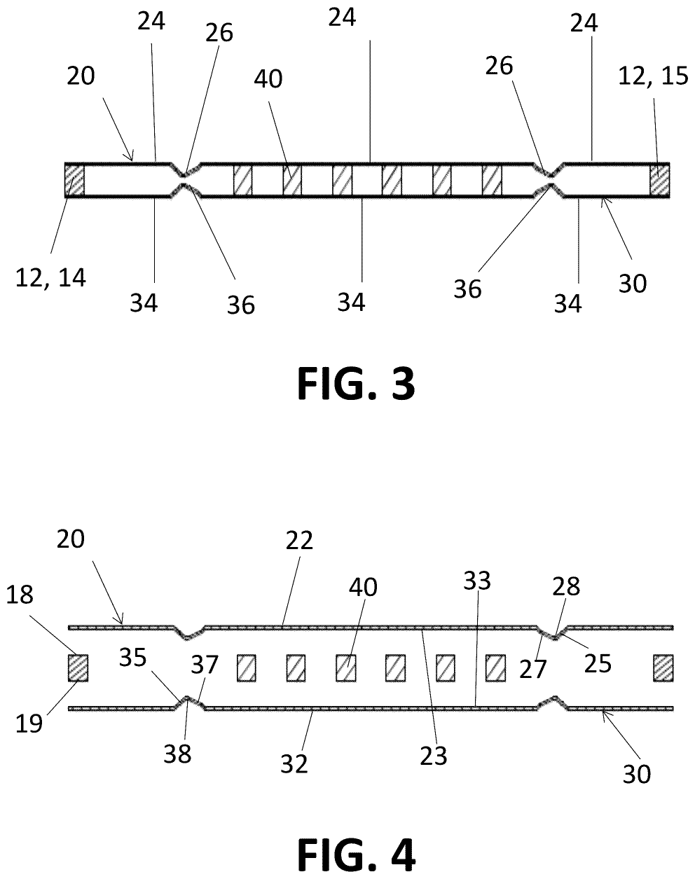

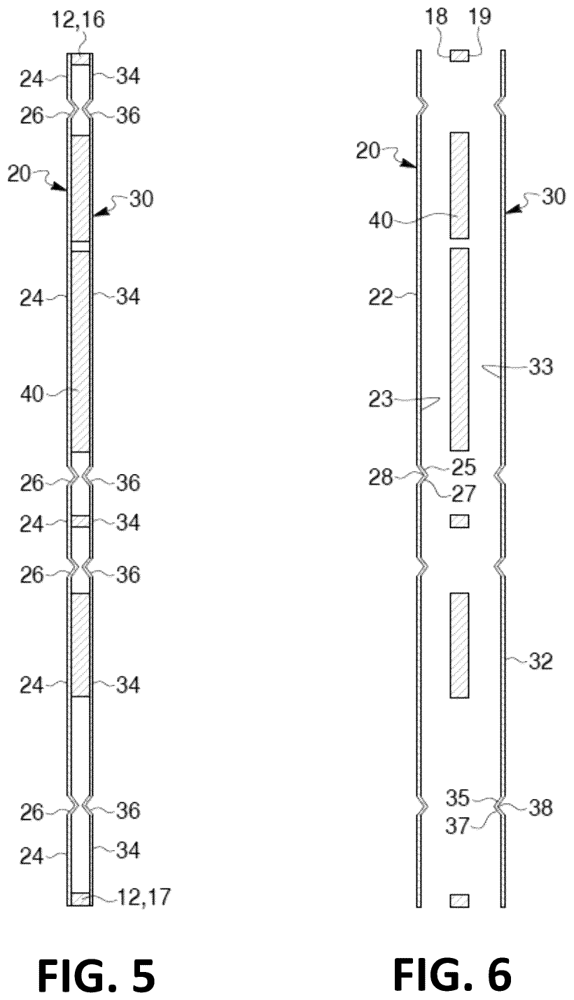

As best shown in FIGS. 1 through 6, an exemplary door 10 includes a peripheral frame 12. The illustrated exemplary frame 12 includes stiles 14 and 15 (shown in the cross section of FIGS. 2 and 3) and top and bottom rails 16 and 17 (shown in cross section in FIGS. 2 and 3-6) connecting the ends of the stiles 14 and 15. Although not shown, the frame 12 may include intermediate rails (extending between and parallel to the rails 16 and 17). The frame 12 may also include one or more lock blocks. As best shown in FIGS. 4 and 6, the frame 12 has a first surface 18 and a second surface 19 opposite to the first surface 18. The frame 12 may be made of, for example, wood, metal, composite (e.g., MDF), other materials, or a combination thereof.

The exemplary door 10 further comprises a first door facing 20 and a second door facing 30. The first and second door facings 20 and 30 may be made of, for example, wood composite, fiberglass-reinforced thermoset, such as a sheet molding compound (SMC), fiberglass-reinforced thermoplastic, steel, or other materials. The first and second door facings 20 and 30 are typically made of the same materials and typically are identical to one another, including having the same appearance and thickness.

As best shown in FIGS. 3, 4, and 5, the exemplary first door facing 20 has a first exterior (or exteriorly disposed) surface 22 and an opposite first interior (or interiorly disposed) surface 23. The first interior surface 23 is secured at its periphery to the first surface 18 of the frame 12. Similarly, the second door facing 30 has a second exterior (or exteriorly disposed) surface 32 and an opposite second interior (or interiorly disposed) surface 33. The second interior surface 33 is secured at its periphery to the second surface 19 of the frame 12. The first and second exterior surfaces 22 and 32 face way from (oppose) one another, while the first and second interior surfaces 23 and 33 face toward one another. The first and second door facings 20 and 30 may be secured to the first and second surfaces 18 and 19 of the frame 12 using adhesive, mechanical fasteners, a combination thereof, or another suitable securing technique. Preferably, adhesive is used to secure the door facings 20 and 30 to the frame 12.

In certain exemplary embodiments, the first and second door facings 20 and 30 may include different regions forming panels in the door. The door 10 shown in FIGS. 1-6 includes paneled door facings 20, 30 having raised regions 24, 34 that are connected by recessed regions 26, 36. Preferably, the door facings 20, 30 are mirror images of each other. The first door facing 20 has raised regions 24 that are coplanar with each other, and recessed regions 26 that are recessed from the raised regions 24. The raised regions 24 form panels. Each of the recessed regions 26 preferably contains a first slope 25 and a second slope 27 (see FIGS. 4 and 6). The first and second slopes 25 and 27 are directly connected to each other and meets at a bottom 28 of the recessed region 26, with the first slope 25 continuous with and connected to the first raised portion 24 and the up slope 27 continuous with and is connected to the second raised portion 24. The second door facing 30 is a mirror image of the first door facing and similarly contains its own raised regions 34, recess regions 36, first slope 35, second slope 37, and bottom 38. Overall, the recessed regions 26, 36 of the first and second door facings 20, 30 connect adjacent raised portions 24, 34, respectively. The slopes 25, 27, 35, 37 may be a straight line directly to the bottom 28, 38 or may include contours as they recess to the bottom 28, 38. The bottoms 28, 38 may be substantially V-shaped as illustrated in FIGS. 3-6; however, the present invention contemplates bottoms 28, 38 containing other shapes, such as U-shape. The distance between the interior surfaces 23, 33 at the recessed regions 26, 36 is less than at the raised regions 24, 34, preferably about 0.600 inch (1.52 cm) to about 0.880 inch (2.24 cm) less.

The raised regions 24, 34 form co-planar panels on the door 10. FIGS. 1-6 shows a two-panel door, where a raised region 24, 34 forming a panel with a recessed region 26, 36 surrounds the panel. Although FIGS. 1-6 depict a two-panel door, a skilled person in the art will recognize that doors with other panel configurations, such as one, three, four, five, six, or more panels, may similarly be formed with raised regions 24, 34 forming the panels, while recessed regions 26, 36 surrounding the raised regions 24, 34. Similarly, while the door 10 has raised panels 24, 34, the principles apply to a door having recessed panels.

The first and second exemplary door facings 20 and 30 of FIGS. 1-6 have identical configurations, as best shown in the cross-sectional views of FIGS. 3-6. The raised region 24, 34 of the first and second door facings 20, 30 are aligned with each other; and the recessed regions 26, 36 of the first and second door facings 20, 30 are aligned with each other.

Although the first and second door facings 20 and 30 are each shown with raised panels, a skilled person in the art would recognize that the panels may be formed with recessed panels, such as that of a shaker door. Each of the door facings may include one more recessed panels. Moreover, while the panels are shown as being rectangular, those skilled in the art will recognize that they may have any configuration, such as being oval.

The door 10 may further include a plurality of exemplary core inserts 40 positioned between the raised portions 24 and 34. However, because the recess regions 26, 36 include no horizontally planar recess panels, core inserts 40 are not placed between the recess regions 26 and 36. The thickness of the core inserts 40 is preferably the same as the nominal thickness of the frame 12, preferably about 1.110 to about 1.140 inches. Each core insert 40 also has a width approximately equal to the thickness, preferably about 1.110 to about 1.140 inches, and a length of 10 inches (±0.0625 inches) to 19 inches (±0.0625 inches). The core inserts 40 are preferably made of corrugated paper or other suitable material, such as expanded polystyrene (EPS). While we prefer that the core inserts are rectangular in plan, they may have other shapes such as circular, oval, triangular, etc, provided that they span and are securable to the opposed door facings 20, 30 in order to prove support thereto.

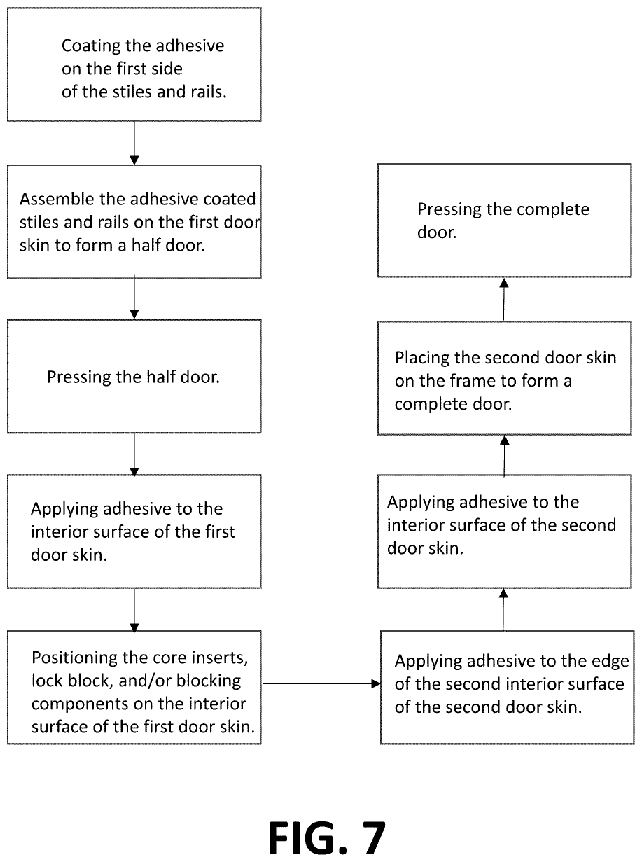

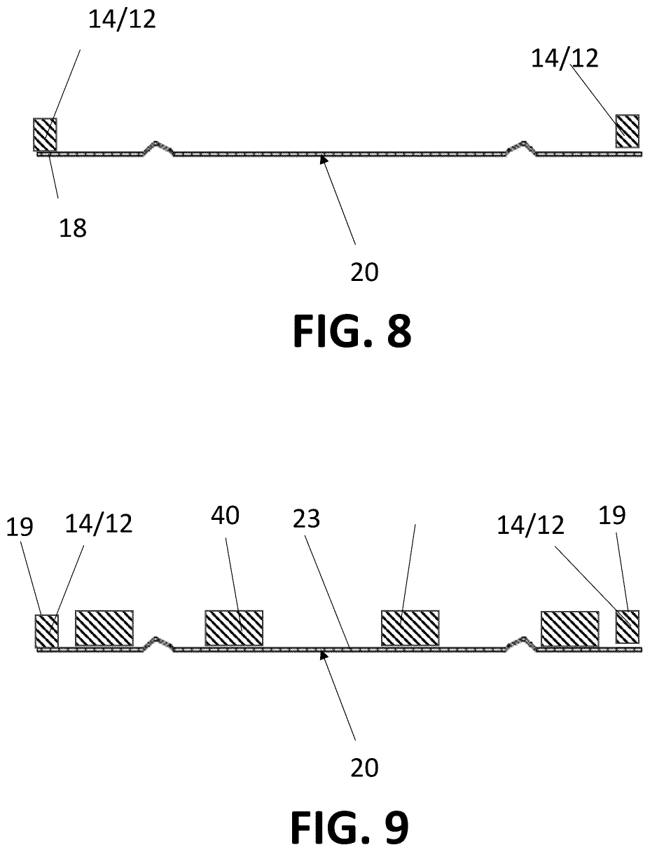

FIG. 7 shows an exemplary process for assembling the door 10. An adhesive is coated, e.g., by a roll coater, on to the first surface 18 of the stiles and rails 16, 17 and stiles 14, 15. The rails 16, 17 and stiles 14, 15 are then assembled on the first door skin 20 such that the first surfaces 18 of the rails 16, 17 and stiles 14, 15 are in contact with the interior surface 23 of the first door skin 20 (see FIG. 8) to assemble a half door. In the half door, the rails 16, 17 and stiles 14, 15 are assembled in their respective position to form the frame 12.

The half door is then pressed in a press under pressure, preferably about 100 PSI, to allow the frame 12 and first door skin 20 to come in intimate contact with each other, and for a period sufficient to allow the adhesive to develop sufficient green strength to keep the door first door skin 20 and frame 12 in their position throughout the assembly process. Green strength is achieved when the adhesive has reached sufficient bonding strength to prevent movement of the door facing and frame relative to each other and to hold the door components together for further handling.

After pressing, adhesive is applied to the interior surface 23 of the first door skin 20. The core inserts 40 are then positioned on the adhesive coated portions of the interior surface 23, as shown in FIG. 9. At the same time, any lock block 42 (see FIG. 2) may also be positioned on the adhesive coated interior surface 23.

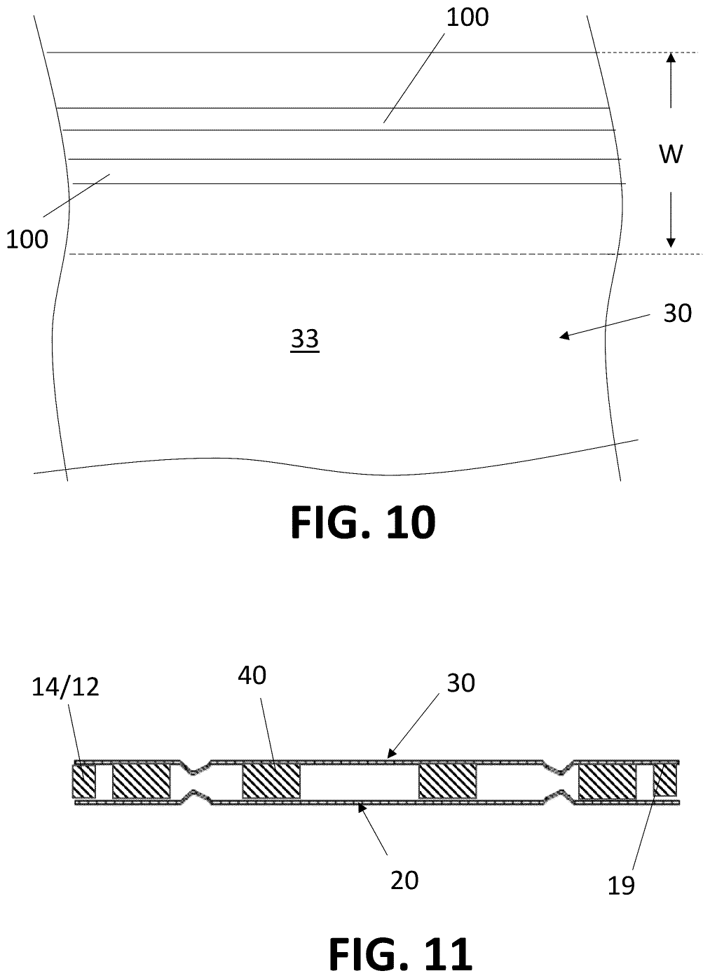

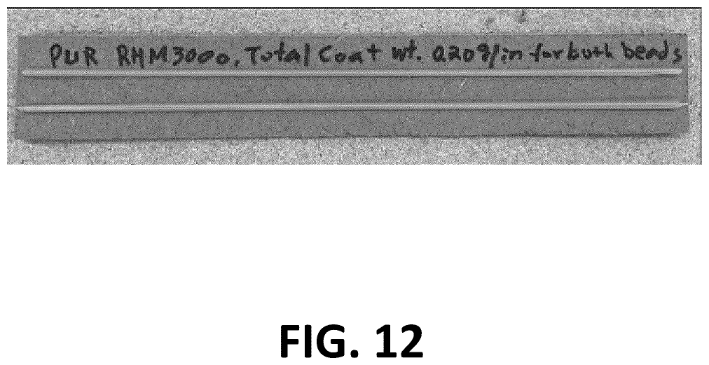

Once the core inserts 40 (and the lock block and/or blocking components) are positioned on the first door skin 20, adhesive is applied to the second interior surface 33 of the second door skin 30. The adhesive is placed on the second interior surface 33 in areas where the frame 12 comes into contact with the second door skin 30. As shown in FIG. 10, which shows a partial edge of the interior surface of the second door skin 30, the adhesive is preferably applied as two lines of round beads 100 on the edge area of the second interior surface 33. Round adhesive beads are preferred because they may be extruded from a glue nozzle. Additionally, due to the nature of the adhesive, the two beads 100 spread and form a film when the door skin 30 is pressed against the stiles and rails of the door frame. In this way, the adhesive coats a substantial portion of the juxtaposed surface of the associated stile or rail.

Each of the two lines 100 are preferably spaced 9/16 in. (±0.005 in.) from the center line of a typical frame 12 having a width W of 1 ⅛ in. (although the lines of adhesives are place on the door skin 30, they are discussed herein relative to the frame 12 for ease of understanding). The lines 100 may be slightly, preferably about 9/16 in., shifted toward the edges of the frame 12 to allow adequate glue line coverage and good glue bond strength later for door edge trimming and performance. Although FIG. 10 shows a partial view of the door skin, the lines 100 of adhesive similarly go completely around the peripheral edges of the second interior surface 33. The preferred adhesive to form the lines 100 is a polyurethane reactive (PUR) adhesive, e.g., available commercially as Rapidex® RHM3000 from H.B. Fuller. Preferably, the PUR adhesive, when being placed on the door skin 30, has a viscosity of about 4600-7000 cPs, an open time of 40 to 60 seconds (open time is the time before the adhesive starts to form a skin), and a temperature of 275-300° F. The unit coat weight of the adhesive on the door skin 30 is preferably about 0.20-0.30 g/in., for both lines of beads 100 combined. Each single bead or line 100 has diameter of about 0.050 to about 0.065 inch.

The application of the two lines of bead 100 on the door skin 30 takes preferably no more than 10 seconds. After that, single bead of adhesive application to the second interior surface 33 of the second door facing 30 can be followed, as needed, to the areas for the core inserts 40 and lock block 42 (see FIG. 2) in preparation for assembly with both door skins 20 and 30.

As an example shown in FIG. 11, the second door skin 30 (having the adhesive lines 100 thereon) is then placed on the frame 12 (with the adhesive lines 100 contacting the second surface 19 of the frame 12). Preferably, the second door skin 30 is placed on the frame 12 in about 30-40 seconds after application of the adhesive to the second door skin 30 and with a slight compressive force of no more than 2-3 PSI. The adhesive adheres the second door skin 30 to the second surface 19 of the frame 12 to form a complete door assembly. The assembly of the second door skin 30 and conveyance to the next step (pressing) is preferably about 40-50 seconds after application of the adhesive to the second door skin 30, which allows the adhesive to achieve adequate green strength.

The complete door assembly is then pressed in a press to allow pressure to be applied to the door 10 to facilitate securing the frame 12 (along with the core insert(s) 40, and lock blocks 42) to the associated door facings. In the press, the adhesive is cured to achieve its sufficient green strength. Preferably, the door 10 is pressed at 100 PSI (±2 PSI) for about 4-5 seconds.

After the door 10 has adequately been bonded by the adhesive, it then may pass through a number of optional finishing operations as needed. For example, the door 10 may be trimmed to size. The door 10 may be passed through a stile and rail trimming station to remove excess material. After the edges have been trimmed, the door may be placed through an edge coating station where the edges of the door 10, such as the exposed rails 16, 17 and stiles 14, 15, are coated or painted. The door 10 may also be subjected to other painting or coating.

In exemplary embodiments, the adhesive is a hot melt adhesive such as PUR. The hot melt adhesive achieves green strength in a very short amount of time to secure the bond between the door skin(s), the frame, and the core inserts and to allow the assembly process to quickly proceed from one step to the next. In an exemplary embodiment, a PUR adhesive comprising polyurethane and isocyanate is used in the above-disclosed system.

The foregoing detailed description of the certain exemplary embodiments has been provided for the purpose of explaining the principles of the invention and its practical application, thereby enabling others skilled in the art to understand the invention for various embodiments and with various modifications as are suited to the particular use contemplated. This description is not necessarily intended to be exhaustive or to necessarily limit the invention to the precise embodiments disclosed.

We claim:

1. A method of assembling a door, comprising:
providing a first assembled half door including a first door skin and a frame;
applying a first adhesive to a first interior surface of the first door skin;
positioning one or more of a: core insert, lock block and blocking component on the interior surface of the first door skin;
applying a second adhesive to an edge of a second interior surface of a second door skin, wherein the edge of the second interior surface of the second door skin is configured to mate with at least a portion of the frame of the first assembled half door;
applying a third adhesive to a third interior surface of the second door skin, wherein the third interior surface is configured to mate with at least a portion of the one or more of the core insert, lock block and locking component;
placing the second door skin on the frame to form a complete door; and
pressing the complete door;
wherein at least one of the first, second and third adhesives is a polyurethane reactive (PUR) configured to achieve green strength within a predetermined time to prevent movement of components relative to one another.

2. A method in accordance with claim 1, wherein one or more of the first, second and third adhesives, when placed on a door skin, has one or more of: a viscosity of about 4600-7000 centi-Pascals (cPs); an open time of 40-60; and a temperature of 275-300 degrees Fahrenheit.

3. A method in accordance with claim 1, wherein the second adhesive has a unit coat weight of the adhesive on a door skin between about 0.20-0.30 grams per inch (g/in) for plural lines of beads provided thereon.

4. A method in accordance with claim 3, wherein the plural lines of beads comprises two beads spaced from the center line of a frame component.

5. A method in accordance with claim 4, wherein the beads have a diameter of between 0.050 to 0.065 inches.

6. A method in accordance with claim 4, wherein the two lines of beads are spaced between 0.562 and 0.563 inches from the center line of the frame component.

7. A method in accordance with claim 3, wherein the application of the plural lines of beads for the second adhesive takes up to 10 seconds.

8. A method in accordance with claim 7, wherein application of the plural lines of beads is provided completely around the peripheral edge of the second interior surface.

9. A method in accordance with claim 7, wherein application of the third adhesive follows application of the second adhesive, with application of one or more single beads of third adhesive on one or more core inserts or lock blocks.

10. A method in accordance with claim 9, wherein the second door skin is placed on the frame components within 30 to 40 seconds after application of the second and third adhesive to complete the door assembly.

11. A method in accordance with claim 10, wherein the pressure of application of the second door skin is between 2 and 3 pounds per square inch (PSI).

12. A method in accordance with claim 10, wherein assembly is automated, and wherein assembly of the second door skin and conveyance to a pressing station is predetermined to be between 40 and 50 seconds after application of the second and third adhesive to the second door skin to allow the adhesive to achieve green strength.

13. A method in accordance with claim 1, wherein assembly is automated, and wherein assembly of the second door skin and conveyance to a pressing station is predetermined to be between 40 and 50 seconds after application of the second and third adhesive to the second door skin to allow the adhesive to achieve green strength, and further wherein the door assembly is pressed in a press to facilitate securing of the components and to allow the adhesive to cure to green strength.

14. A method in accordance with claim 13, wherein pressing time is between 4 and 5 seconds.

15. A method in accordance with claim 13, wherein pressing occurs between 98 and 102 PSI.

16. A method in accordance with claim 1, wherein the PUR adhesive is a polyurethane and isocyanate adhesive.

17. A method in accordance with claim 1, wherein the frame includes stile and rail frame components.

18. A method in accordance with claim 1, wherein the core insert comprises plural core inserts arranged in parallel.

19. A method in accordance with claim 1, wherein the core insert comprises plural core inserts arranged in staggered positions.

20. A method in accordance with claim 1, wherein the assembly is an automated assembly using one or more glue nozzles.
